(19) United States
(12) Patent Application Publication
(10) Pub. No.: US 2010/0116814 A1
(43) Pub. Date: May 13, 2010

(54) Heating Process that Keeps a Heating Apparatus at a Constant Temperature by the Power Supply of a Portable Battery

(76) Inventor: Chien-Chou Chen, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/270,047

(22) Filed: Nov. 13, 2008

(51) Int. Cl. H05B 1/00

(52) U.S. Cl. 219/490

(57) ABSTRACT

A heating apparatus includes a portable battery, a controller connected to the portable battery, and a heating module connected to the controller. The controller is provided with a software program that previously detects the voltage variation of the portable battery to change the on/off percentage of the duty cycle of the portable battery and to regulate the output current of the portable battery according to the preset temperature and the detected voltage variation of the portable battery, so that the input current of the heating module is kept at a constant value, and the temperature of the heating module of the heating apparatus is kept at a constant value of the preset temperature at any time.

### BACKGROUND OF THE INVENTION

1. Field of the Invention

The present invention relates to a heating process and, more particularly, to a heating process for a heating apparatus.

2. Description of the Related Art

A conventional heating apparatus in accordance with the prior art shown in FIG. 5 comprises a control plate 12 mounted between a portable battery 11 and a heating module 13. The control plate 12 is provided with at least one resistor 121 connected with the portable battery 11 and a transistor 122 connected with the heating module 13. Thus, the portable battery 11 supplies an electric power to the heating module 13 so as to increase the temperature of the heating module 13. However, the voltage of the portable battery 11 is decreased gradually when the discharging time of the portable battery 11 is increased, so that the current of the portable battery 11 is decreased gradually, and the temperature of the heating module 13 is decreased gradually (the resistance of the heating module 13 is fixed). Thus, the temperature of the heating module 13 cannot be kept at a constant value when the power supply of the conventional heating apparatus is supplied by a portable miniature battery.

Another conventional heating apparatus in accordance with the prior art shown in FIG. 6 comprises a temperature controller 22 mounted between a portable battery 21 and a heating module 23. The temperature controller 22 is provided with a control IC (integrated circuit) 221 connected between the portable battery 21 and the heating module 23. Thus, the portable battery 21 supplies an electric power to the heating module 23 so as to increase the temperature of the heating module 23. In practice, the control IC 221 of the temperature controller 22 can control the on/off percentage (or frequency) of the duty cycle of the portable battery 21. In such a manner, when the on percentage of the duty cycle of the portable battery 21 is increased, the current of the portable battery 21 is increased, and the temperature of the heating module 23 is increased, and when the off percentage of the duty cycle of the portable battery 21 is decreased, the current of the portable battery 21 is decreased, and the temperature of the heating module 23 is decreased. Thus, the control IC 221 of the temperature controller 22 can control the on/off percentage (or frequency) of the duty cycle of the portable battery 21 to control the temperature of the heating module 23 in multiple steps. However, the voltage of the portable battery 21 is decreased gradually when the discharging time is increased, so that the current of the portable battery 21 is decreased gradually, and the temperature of the heating module 23 is decreased gradually (the resistance of the heating module 23 is fixed). Thus, the temperature of the heating module 23 cannot be kept at a constant value when the power supply of the conventional heating apparatus is supplied by a portable miniature battery.

### BRIEF SUMMARY OF THE INVENTION

In accordance with the present invention, there is provided a heating process for a heating apparatus. The heating apparatus includes a portable battery, a controller connected to the portable battery, and a heating module connected to the controller by two connecting wires. The heating process includes providing a preset temperature and providing a software program in the controller. The software program of the controller previously detects a voltage variation of the portable battery to change an on/off percentage of a duty cycle of the portable battery and to regulate an output current of the portable battery according to the preset temperature and the detected voltage variation of the portable battery, so that the input current of the heating module is kept at a constant value, and the temperature of the heating module of the heating apparatus is kept at a constant value of the preset temperature at any time. The software program of the controller decreases the on percentage of the duty cycle of the portable battery and increases the off percentage of the duty cycle of the portable battery when the voltage of the portable battery is grater than a working voltage of the portable battery so as to decrease the output current of the portable battery. The software program of the controller increases the on percentage of the duty cycle of the portable battery and decreases the off percentage of the duty cycle of the portable battery when the voltage of the portable battery is smaller than the working voltage of the portable battery so as to increase the output current of the portable battery.

The primary objective of the present invention is to provide a heating process that keeps a heating apparatus at a constant temperature by the power supply of a portable battery.

Another objective of the present invention is to provide a heating process, wherein the controller previously detects the voltage variation of the portable battery to randomly change the on/off percentage of the duty cycle of the portable battery and to regulate (decrease or increase) the output current of the portable battery according to the detected voltage variation of the portable battery, so that the input current of the heating module is kept at a constant value, and the temperature of the heating module of the heating apparatus is kept at a constant value (the preset temperature) at any time even if the voltage of the portable battery is changed at any time.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a block diagram of a heating apparatus in accordance with the preferred embodiment of the present invention.

FIG. 2 is a circuit layout of a controller of the heating apparatus as shown in FIG. 1.

FIG. 3 is a discharging profile of a portable battery of the heating apparatus as shown in FIG. 1.

FIG. 4 is a profile of an on/off action of a duty cycle of the portable battery of the heating apparatus as shown in FIG. 1.

FIG. 5 is a block diagram of a conventional heating apparatus in accordance with the prior art.

FIG. 6 is a block diagram of another conventional heating apparatus in accordance with the prior art.

### DETAILED DESCRIPTION OF THE INVENTION

First of all, when the power supply of a heating apparatus is supplied by an AC (alternating current) power supply or a steady-state DC (direct current) power supply, the voltage of the power supply is constant at any time, so that the current of the power supply is constant, and the temperature of the heating apparatus is constant at any time. Thus, the heating apparatus is kept at the state of a constant temperature to function as a thermostat so as to keep the temperature at a constant value. On the contrary, when the power supply of the heating apparatus is supplied by a portable miniature battery (such as a lithium battery), the voltage of the battery is decreased gradually when the discharging time is increased, so that the current of the battery is decreased gradually, and the temperature of the heating apparatus is decreased gradually. Thus, the heating apparatus cannot be kept at the state of a constant temperature when the power supply of the conventional heating apparatus is supplied by a portable miniature battery.

Therefore, a heating process in accordance with the preferred embodiment of the present invention is used to keep a heating apparatus at a constant temperature by the power supply of a portable miniature battery (such as a lithium battery).

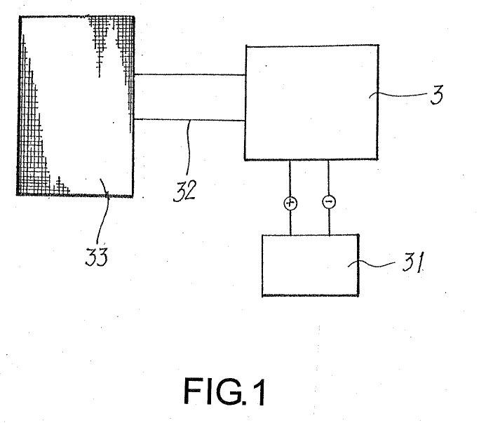

Referring to the drawings and initially to FIG. 1, a heating apparatus in accordance with the preferred embodiment of the present invention comprises a portable battery 31, a controller 3 connected to the portable battery 31, and a heating module 33 connected to the controller 3 by two connecting wires 32. The controller 3 is provided with a software program that previously detects the voltage variation of the portable battery 31 to control an on/off percentage (or frequency) of a duty cycle of the portable battery 31. Thus, the temperature is preset when the portable battery 31 is started. Then, the controller 3 previously detects the voltage variation of the portable battery 31 to change the on/off percentage of the duty cycle of the portable battery 31 and to regulate the output current of the portable battery 31 according to the preset temperature and the detected voltage variation of the portable battery 31, so that the input current of the heating module 33 is kept at a constant value, and the temperature of the heating module 33 of the heating apparatus is kept at a constant value (the preset temperature) at any time.

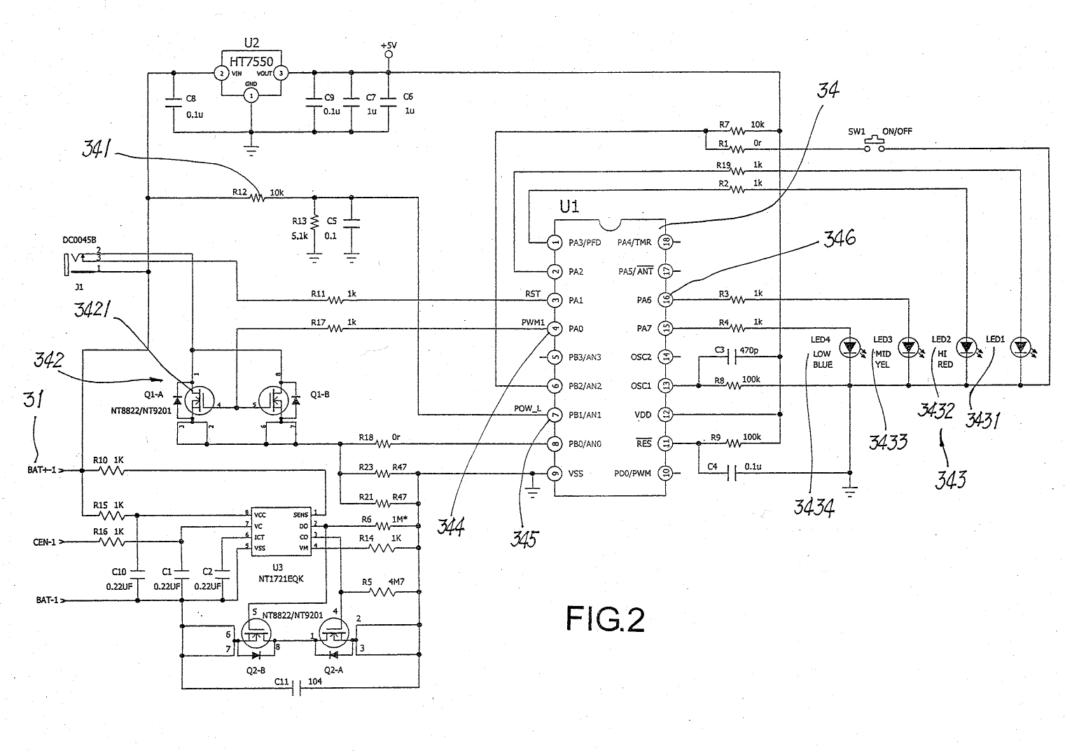

In practice, referring to FIG. 2 with reference to FIG. 1, the controller 3 is provided with a control IC (integrated circuit) 34. The seventh leg 345 of the control IC 34 is connected to a resistor 341 that is used for a low voltage detection of the portable battery 31. When the current of the portable battery 31 passes through the resistor 341, the voltage of the portable battery 31 is regulated by the resistor 341. Thus, when the voltage of the portable battery 31 is greater than a preset value (5.6V), the voltage of the portable battery 31 is regulated by the resistor 341 to the working voltage (ranged between 2.8V and 2.3V) of the control IC 34 even if the voltage of the portable battery 31 is disposed at a saturated value (8.4V). If not so, the control IC 34 will stop operating automatically. On the contrary, when the voltage of the portable battery 31 is lower than the preset value (5.6V), the voltage of the portable battery 31 cannot be regulated by the resistor 341 to the working voltage (ranged between 2.8V and 2.3V) of the control IC 34, so that the control IC 34 will stop operating.

After the low voltage detection of the portable battery 31 is accomplished, the fourth leg 344 of the control IC 34 is connected to an impulse IC 342 which is provided with a transistor 3421 that is operated to control the on/off percentage of the duty cycle of the portable battery 31. In such a manner, the temperature is preset when the portable battery 31 is started. Then, the control IC 34 of the controller 3 automatically detects the voltage variation of the portable battery 31. Then, the transistor 3421 of the impulse IC 342 is driven by the fourth leg 344 of the control IC 34 to change the on/off percentage of the duty cycle of the portable battery 31 and to regulate the output current of the portable battery 31 according to the detected voltage variation of the portable battery 31, so that the input current of the heating module 33 is kept at a constant value, and the temperature of the heating module 33 of the heating apparatus is kept at a constant value (the preset temperature) at any time. At the same time, the control IC 34 is connected to an indication unit 343 which is used to indicate the on/off percentage of the duty cycle of the portable battery 31.

In the preferred embodiment of the present invention, the indication unit 343 is designed to indicate the on/off percentage of a four-step temperature. The indication unit 343 includes a first LED (light emitting diode) 3431 to indicate the on/off percentage (the on action of the output current is 25% and the off action of the output current is 75%) under the maximum temperature, a second LED 3432 to indicate the on/off percentage (the on action of the output current is 50% and the off action of the output current is 50%) under the higher temperature, a third LED 3433 to indicate the on/off percentage (the on action of the output current is 75% and the off action of the output current is 25%) under the lower temperature, and a fourth LED 3434 to indicate the on/off percentage (the on action of the output current is 100% and the off action of the output current is 0%) under the minimum temperature. For example, if the lower temperature is chosen, the third LED 3433 of the indication unit 343 is lighted. At this time, the third LED 3433 of the indication unit 343 is connected to the sixteenth leg 346 of the control IC 34 so that the on action of the output current is 75% and the off action of the output current is 25%. Thus, when the voltage of the portable battery 31 is steady, the on action of the output current is 75% and the off action of the output current is 25%.

At this time, the seventh leg 345 of the control IC 34 can detect the voltage variation of the portable battery 31 to randomly change the on/off percentage of the duty cycle of the portable battery 31 and to regulate the output current of the portable battery 31 according to the detected voltage variation of the portable battery 31, so that the input current of the heating module 33 is kept at a constant value, and the temperature of the heating module 33 of the heating apparatus is kept at a constant value at any time even if the voltage of the portable battery 31 is changed at any time.

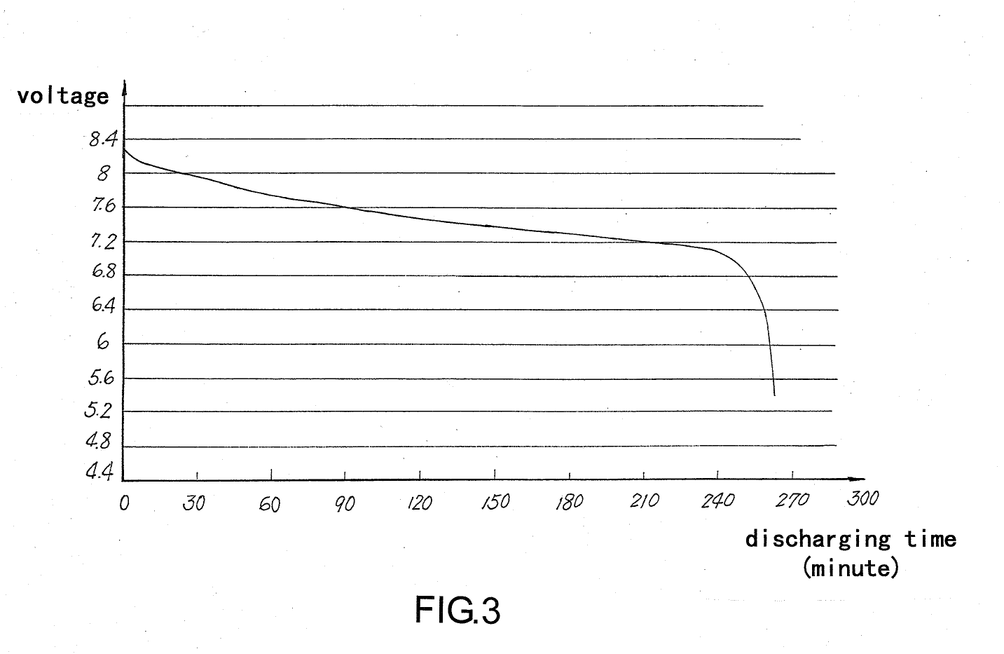

Referring to FIG. 3 with reference to FIGS. 1 and 2, the output voltage (or current) of the portable battery 31 is decreased gradually when the discharging time is increased. The working voltage of the portable battery 31 is 3.7V, the saturated voltage of the portable battery 31 is 4.2V (greater than the working voltage), and the protection voltage of the portable battery 31 is 2.8V so that when the voltage of the portable battery 31 is lower than 2.8V, the controller 3 and the portable battery 31 stop working. Thus, when two portable batteries 31 are connected serially, the working voltage of the two portable batteries 31 is 7.4V, the saturated voltage of the two portable batteries 31 is 8.4V, and the protection voltage of the two portable batteries 31 is 5.6V.

As shown in FIG. 3, the output (or discharging) voltage of the portable battery 31 has the maximum value (8.4V) when the portable battery 31 is disposed at the saturated state, and is then decreased gradually when the discharging time is increased. In addition, the output current of the portable battery 31 is kept constant for a period of time at the working voltage (7.2V to 7.6V), and is then decreased rapidly to the protection voltage (5.6V), and the controller 3 and the portable battery 31 stop working at the protection voltage (5.6V). Thus, the output current of the portable battery 31 is decreased successively when the voltage of the portable battery 31 is decreased, so that the temperature is also decreased successively and cannot be kept at the preset value.

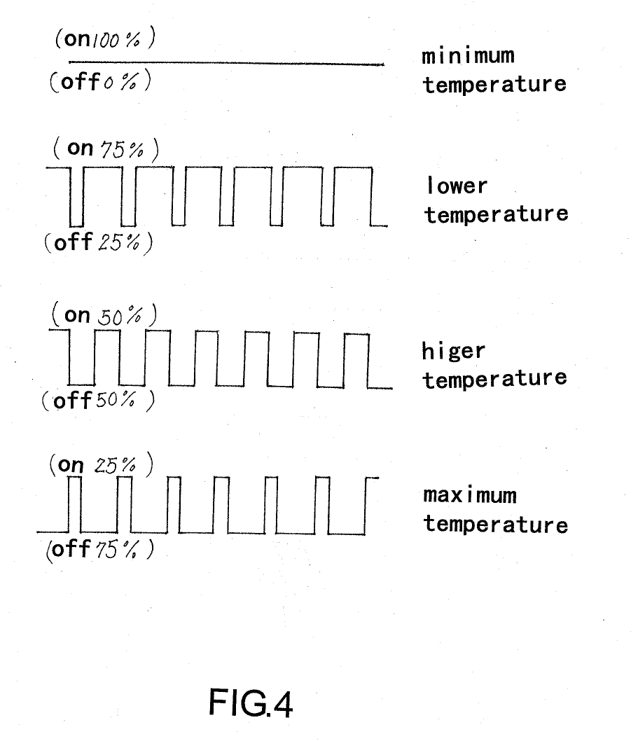

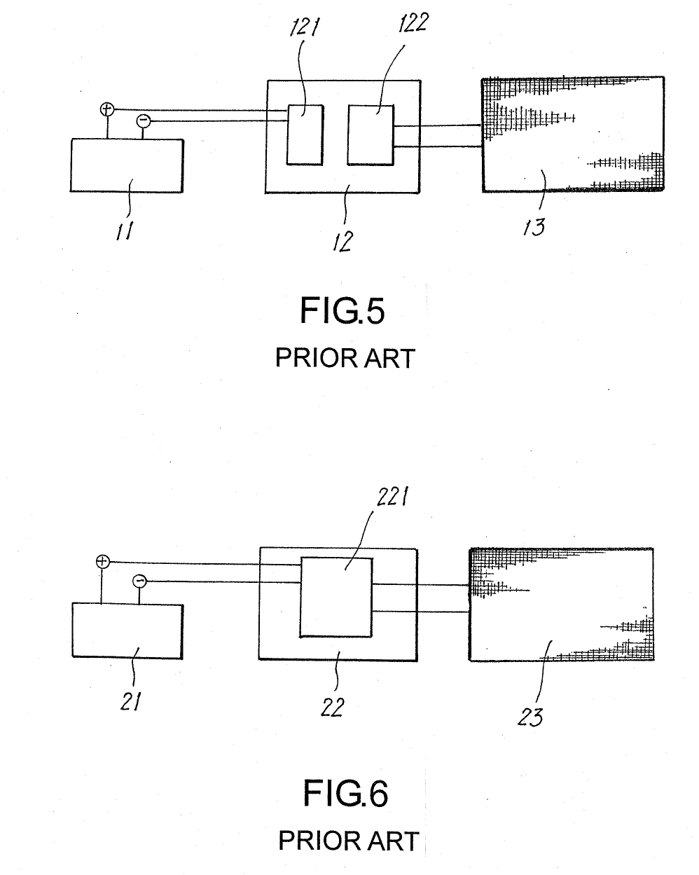

Referring to FIG. 4 with reference to FIGS. 1-3, the output current of the portable battery 31 is controlled by actions of the on/off percentage of the duty cycle of the portable battery 31. In the preferred embodiment of the present invention, the actions of the on/off percentage of the duty cycle of the portable battery 31 are performed by four steps. In the first step of the maximum temperature, the on action of the output current is 25% and the off action of the output current is 75%. In the second step of the higher temperature, the on action of the output current is 50% and the off action of the output current is 50%. In the third step of the lower temperature, the on action of the output current is 75% and the off action of the output current is 25%. In the fourth step of the minimum temperature, the on action of the output current is 100% and the off action of the output current is 0%. The controller 3 is provided with a software program that previously detects the voltage variation of the portable battery 31 to control the on/off percentage of the duty cycle of the portable battery 31.

In such a manner, when the voltage of the portable battery 31 is greater than the working voltage, the percentage of the on action of the output current is decreased, and the percentage of the off action of the output current is increased to decrease the output current of the portable battery 31 so as to keep the temperature of the heating module 33 of the heating apparatus at a constant value, and when the voltage of the portable battery 31 is lower than the working voltage, the percentage of the on action of the output current is increased, and the percentage of the off action of the output current is decreased to increase the output current of the portable battery 31 so as to keep the temperature of the heating module 33 of the heating apparatus at a constant value (the preset temperature).

Thus, the controller 3 previously detects the voltage variation of the portable battery 31 to randomly change the on/off percentage of the duty cycle of the portable battery 31 and to regulate (decrease or increase) the output current of the portable battery 31 according to the detected voltage variation of the portable battery 31, so that the input current of the heating module 33 is kept at a constant value, and the temperature of the heating module 33 of the heating apparatus is kept at a constant value (the preset temperature) at any time even if the voltage of the portable battery 31 is changed at any time.

In other word, when the portable battery 31 is disposed at the saturated state, the voltage of the portable battery 31 has the maximum value, the output current of the portable battery 31 has the maximum value, so that the temperature of the heating module 33 has the maximum value. Similarly, when the voltage of the portable battery 31 has the minimum value, the output current of the portable battery 31 has the minimum value, so that the temperature of the heating module 33 has the minimum value. In such a manner, when the portable battery 31 has a higher voltage (greater than the working voltage) and higher output current (that is, the heating module 33 has a higher temperature), the on action of the duty cycle of the portable battery 31 has a lower percentage, and the off action of the duty cycle of the portable battery 31 has a higher percentage. On the contrary, when the portable battery 31 has a lower voltage (smaller than the working voltage) and lower output current (that is, the heating module 33 has a lower temperature) during a period of time, the on action of the duty cycle of the portable battery 31 has a higher percentage, and the off action of the duty cycle of the portable battery 31 has a lower percentage. Thus, the controller 3 previously detects the voltage variation of the portable battery 31 to randomly change the on/off percentage of the duty cycle of the portable battery 31 and to regulate (decrease or increase) the output current of the portable battery 31 according to the detected voltage variation of the portable battery 31, so that the input current of the heating module 33 is kept at a constant value, and the temperature of the heating module 33 is kept at a constant value (the preset temperature) at any time even if the voltage of the portable battery 31 is changed at any time.

An example is used to illustrate the variation of the voltage, current and power when using the heating process of the present invention.

In the preferred embodiment of the present invention, assuming 1) the load of the heating module 33 is 0.45 A (ampere), 2) the content of the portable battery 31 is 2200 mAh (millimeter ampere hour), 3) the working voltage of the portable battery 31 is 7.4V (volt) when two batteries are connected serially, 4) the resistance of the heating module 33 is 16.44Ω (ohm), and 5) the preset temperature is 50° C. (centigrade), the relation of the voltage (V), power (P), current (I) and resistance (R) is listed as follows according the formulas of P=I*V and I=V/R.

| V | P | I | R |
|---|---|---|---|
| 8.4 | 4.4 W | 0.525 A | 16.44 Ω |
| 8.3 | 4.3 W | 0.519 A | 16.44 Ω |
| . | . | . | . |
| 7.5 | 3.42 W | 0.456 A | 16.44 Ω |
| 7.4 | 3.3 W | 0.45 A | 16.44 Ω |
| 7.3 | 3.2 W | 0.444 A | 16.44 Ω |
| . | . | . | . |
| 5.6 | 1.9 W | 0.34 A | 16.44 Ω |

Then, the on/off percentage of the duty cycle of the portable battery 31 is changed according to the voltage variation of the portable battery 31 and is listed in the following table.

| V | on | off |
|---|---|---|
| 8.4 V | 400/1000 | 600/1000 |
| 8.3 V | 435/1000 | 565/1000 |
| . | . | . |
| 7.5 V | 715/1000 | 285/1000 |
| 7.4 V | 750/1000 | 250/1000 |
| 7.3 V | 785/1000 | 215/1000 |
| . | . | . |
| 5.7 V | 960/1000 | 40/1000 |
| 5.6 V | 995/1000 | 5/1000 |

Thus, in the above table, the duty cycle of the portable battery 31 is 1000 times/second. For example, when the voltage of the portable battery 31 reaches 7.4V (the working voltage), the on action of the output current is 75% (750/1000) and the off action of the output current is 25% (250/1000).

Accordingly, the controller 3 previously detects the voltage variation of the portable battery 31 to randomly change the on/off percentage of the duty cycle of the portable battery 31 and to regulate (decrease or increase) the output current of the portable battery 31 according to the detected voltage variation of the portable battery 31, so that the input current of the heating module 33 is kept at a constant value, and the temperature of the heating module 33 of the heating apparatus is kept at a constant value (the preset temperature) at any time even if the voltage of the portable battery 31 is changed at any time.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A heating process for a heating apparatus;
the heating apparatus comprising a portable battery, a controller connected to the portable battery, and a heating module connected to the controller by two connecting wires;
the heating process comprising:
providing a preset temperature;
providing a software program in the controller;
the software program of the controller previously detecting a voltage variation of the portable battery to change an on/off percentage of a duty cycle of the portable battery and to regulate an output current of the portable battery according to the preset temperature and the detected voltage variation of the portable battery, so that the input current of the heating module is kept at a constant value, and a temperature of the heating module of the heating apparatus is kept at a constant value of the preset temperature at any time;
the software program of the controller decreasing the on percentage of the duty cycle of the portable battery and increasing the off percentage of the duty cycle of the portable battery when the voltage of the portable battery is grater than a working voltage of the portable battery so as to decrease the output current of the portable battery;
the software program of the controller increasing the on percentage of the duty cycle of the portable battery and decreasing the off percentage of the duty cycle of the portable battery when the voltage of the portable battery is smaller than the working voltage of the portable battery so as to increase the output current of the portable battery.
